(19) United States
(12) Patent Application Publication
(10) Pub. No.: US 2004/0061307 A1
(43) Pub. Date: Apr. 1, 2004

(54) Anti-jackknife semi-trailer attachment

(76) Inventor: Wiliam R. Cole, Plainfield, IN (US)

Correspondence Address: WILLIAM R. COLE, 8760 S. C.R. 825 E., PLAINFIELD, IN, 46168, US

(21) Appl. No.: 10/632,314

(22) Filed: Aug. 1, 2003

Related U.S. Application Data
(60) Provisional application No. 60/400,737, filed on Aug. 2, 2002.

(51) Int. Cl. B62D 53/06

(52) U.S. Cl. 280/432

(57) ABSTRACT

A anti-jackknife semi-trailer attachment system is for preventing a trailer from jackknifing when coupled to a trailer. The anti-jackknife system is attached to the trailer.

### SUMMARY OF INVENTION

A anti-jackknife semi-trailer attachment system is for preventing a trailer from jackknifing when coupled to a trailer. The anti-jackknife system is attached to the trailer.

### DESCRIPTION OF DRAWINGS

The invention is described below with reference to the following figures.

FIG. 1 Is a schematic top view of the turntable that will be installed in place by a king pin mounting that will attach the two plates together.

FIG. 2 Is a schematic bottom view of the turntable that will be installed in place by a king pin mounting that will attached the top and bottom plates together.

FIG. 2 (insert) This is a drawing of the wedge that locks the turntable to the tractor fifth wheel.

FIG. 3 Is a schematic view of roller assembly that allows the turntable to turn inside the structural members of the trailer.

FIG. 4 Is a schematic clarification of the roller system.

FIG. 5 Is a detailed drawing of the internal gears of the system, (not to scale). The color shown on the claimed design/photograph(s) forms no part thereof.

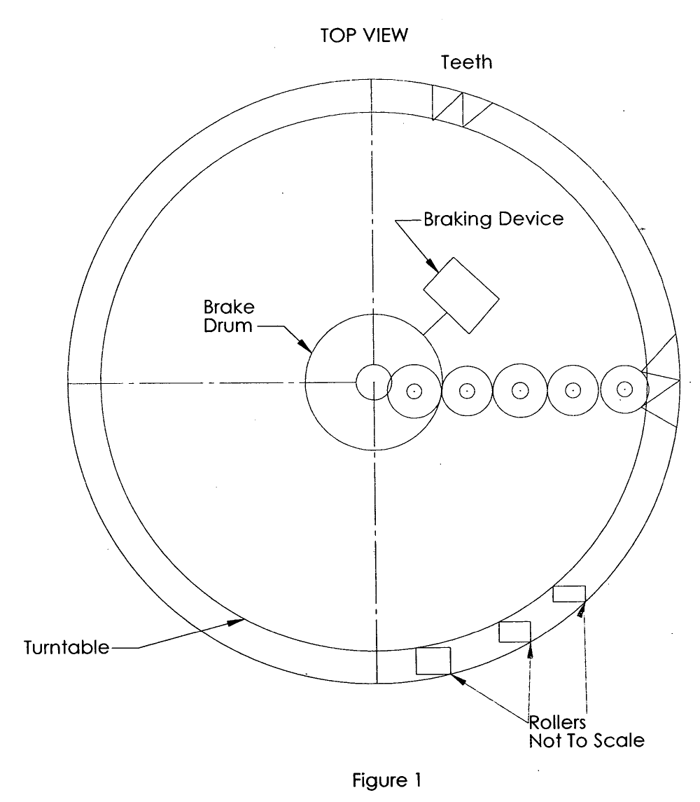

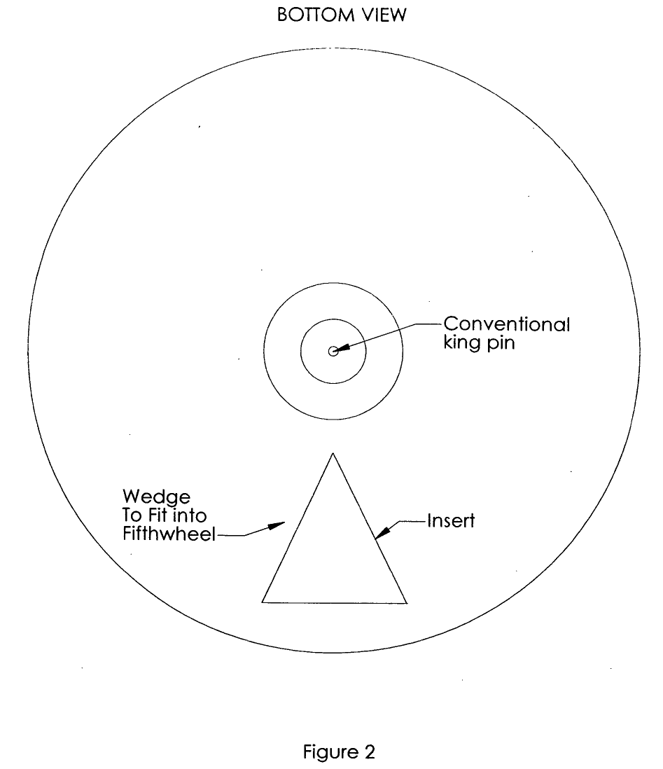

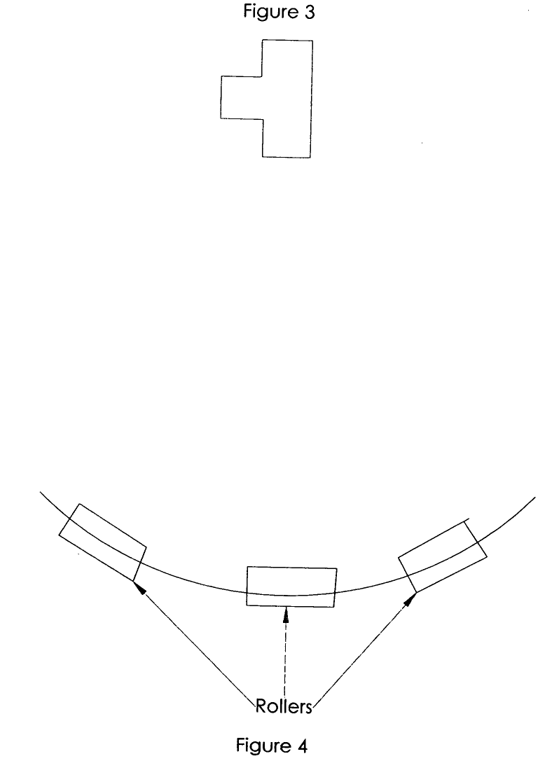

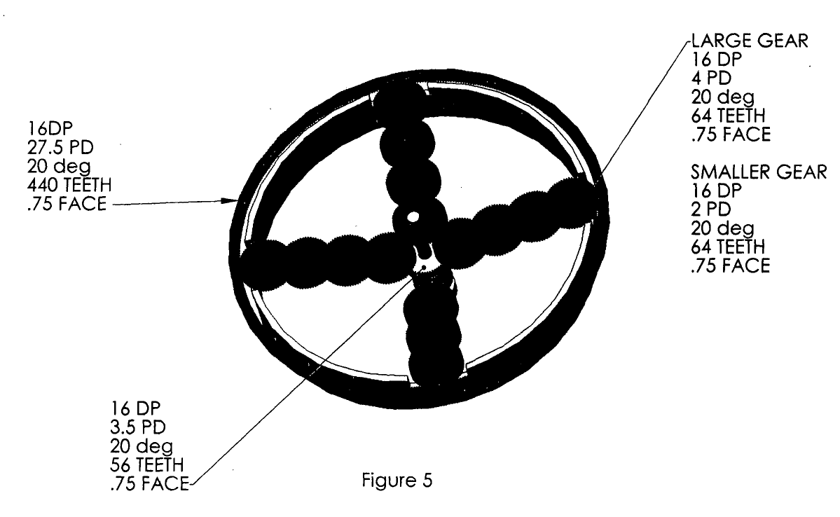

### DESCRIPTION

The Tractor and Trailer will be connected together in the conventional manner. Once connected the turntable replaces the conventional flat surfaces between the trailer and the fifth wheel. This attachment enables the driver in emergency and unusual road conditions to maintain control of the tractor.

What is claimed is:

1. The Anti-Jackknife Semi-Trailer Attachment is attached directly to the trailer

2. The Anti-Jackknife Semi-Trailer Attachment operates by remote control

3. The Anti-Jackknife Semi-Trailer Attachment requires no modifications to the Tractor
